(19) United States
(12) Patent Application Publication
(10) Pub. No.: US 2022/0343323 A1
(43) Pub. Date: Oct. 27, 2022

(54) METHOD AND APPARATUS MAINTAINING PRIVATE DATA WITH CONSORTIUM BLOCKCHAIN

(71) Applicant: Hitachi, Ltd., Chiyoda-ku, Tokyo (JP)

(72) Inventors: Taku SHIMOSAWA, Santa Clara, CA (US); Satoshi OSHIMA, Tokyo (JP)

(21) Appl. No.: 17/640,316

(22) PCT Filed: Mar. 30, 2020
(86) PCT No.: PCT/US2020/025780

§ 371 Date: Mar. 3, 2022

(51) Int. Cl. G06Q 20/38; G06Q 20/40; H04L 9/00

(52) U.S. Cl. CPC G06Q 20/389; G06Q 20/401; H04L 9/50

(57) ABSTRACT

Method and apparatus maintaining private data with consortium blockchain is disclosed. In blockchain, a transaction is required to be verified by one or multiple nodes that are participating in the blockchain. Verification by multiple nodes is key to the immutability and consensus of the blockchain. However, when private data, which is to be disclosed to only a part of the nodes, are used in a transaction, it is likely that most or even none of the nodes can verify the transaction. The system and method disclosed herein introduces read-only organizations and allows them to serve as third-party trustful mediators to perform the necessary verification for such transactions. Through example implementations herein, the implementations can serve as a trustful third-party entity in blockchain systems and/or provide various services including auditing and integration tests in blockchain-based systems.

### BACKGROUND

### Field

The present disclosure generally relates to blockchain systems, and more specifically, to systems and methods for maintaining private data with consortium blockchain.

### Related Art

In related art implementations, such as that disclosed in US 2019/0251566A1, there are systems and methods to facilitate private transactions on a consortium blockchain. Private data in transactions are recorded in a specific client node, and the hash values for the data are recorded in the blockchain network. A client node has communication channels that are each private to another client node. Therefore private transactions between two client nodes can be issued using the channel without exposing the transactions to other client nodes. By referring to the hashes recorded in the blockchain network, a client node can verify data in the private transaction that are passed from another organization and ensure that the data have not been altered since they are stored.

### SUMMARY

However, the related art implementations do not disclose a method to handle so-called the SPoT (single point of trust) issue for private data.

Example implementations described herein are directed to systems and methods with a consortium blockchain. Consortium blockchain is known as permissioned blockchain or enterprise blockchain, and is configured to limit the access to only a set of known participants, is not anonymous, and is not open to the public. In a consortium blockchain, participants are also grouped into organizations; every participant must belong to one and only organization. Blockchain is facilitated through multiple computer nodes, each of which belongs to a particular organization, are connected, and communicate with one another. Data shared and distributed in the system is called a ledger, and each computer node has a ledger locally. The blockchain maintains every computer node which is participating in the blockchain so that it has the same contents for the ledger in the system (i.e., every blockchain node has a replica of the ledger, which eventually has the same contents).

Data models used in the blockchain include UTXO (unspent transaction output) and key-value pairs. The ledger typically contains only transactions, wherein each transaction contains values only for the relevant data (which are identified by addresses in UTXO, keys in key-value). While it is possible to get the latest values for all the data by traversing all the history, or transactions in the ledger, the blockchain nodes can also optionally have the snapshot of the latest data for efficiency and update it for every new transaction.

Various consensus algorithms are used to facilitate maintaining the same ledger in the computer nodes in blockchain systems. One example is the three-phase consensus in Hyperledger Fabric, which involves endorsement, ordering and validation. In the endorsement phase, a client requests a transaction to blockchain nodes by sending a transaction proposal. A blockchain node executes a program which is called a smart contract according to the transaction proposal, and sends back the result with the signature of the node, which is called an endorsement, to the client. In the ordering phase, a client sends a transaction, which involves the proposal and the endorsement(s), to the special blockchain node(s) that are specialized for determining the order of the transactions. The node(s) providing the ordering service determine the order of the transactions received, and create blocks by aggregating one or multiple transactions. In the validation phase, the ordering service delivers the blocks to the blockchain nodes. The blockchain nodes inspect each transaction in every block and check if the endorsements are valid and the result does not conflict with other “previous” transactions. When a transaction passes all the checks, it is considered valid, and if the blockchain nodes have snapshot data, it updates the snapshot according to the result of the transaction. Otherwise, it is considered invalid and has no effect. The following explanation is based on this three-phase consensus, but the example implementations are not limited to the particular algorithm.

Aspects of the present disclosure can include a method for a blockchain system configured to facilitate a smart contract transaction, the blockchain system having a plurality of nodes, the method involving: responsive to receiving, at a first node from the plurality of nodes, a proposal for the smart contract transaction from a second node of the plurality of nodes, identifying, at the first node, an organization in the blockchain system associated with the second node; determining, at the first node, whether the organization is capable of executing the smart contract transaction indicated by the proposal; for the determining indicating that the organization does not have capability of executing the smart contract transaction indicated by the proposal, returning an error to the second node; and for the determining indicating that the organization does have capability of executing the smart contract transaction indicated by the proposal, executing the smart contract transaction.

Aspects of the present disclosure can include a non-transitory computer readable medium, storing instructions for a blockchain system configured to facilitate a smart contract transaction, the blockchain system involving a plurality of nodes, the instructions involving: responsive to receiving, at a first node from the plurality of nodes, a proposal for the smart contract transaction from a second node of the plurality of nodes, identifying, at the first node, an organization in the blockchain system associated with the second node; determining, at the first node, whether the organization is capable of executing the smart contract transaction indicated by the proposal; for the determining indicating that the organization does not have capability of executing the smart contract transaction indicated by the proposal, returning an error to the second node; and for the determining indicating that the organization does have capability of executing the smart contract transaction indicated by the proposal, executing the smart contract transaction.

Aspects of the present disclosure can include a blockchain system configured to facilitate a smart contract transaction, the blockchain system having a plurality of nodes, the blockchain system involving: responsive to receiving, at a first node from the plurality of nodes, a proposal for the smart contract transaction from a second node of the plurality of nodes, means for identifying, at the first node, an organization in the blockchain system associated with the second node; means for determining, at the first node, whether the organization is capable of executing the smart contract transaction indicated by the proposal; for the determining indicating that the organization does not have capability of executing the smart contract transaction indicated by the proposal, means for returning an error to the second node; and for the determining indicating that the organization does have capability of executing the smart contract transaction indicated by the proposal, means for executing the smart contract transaction.

Aspects of the present disclosure can include a blockchain system configured to facilitate a smart contract transaction, the blockchain system involving a plurality of nodes; wherein a first node of the plurality of nodes involve a processor, configured to, responsive to receiving a proposal for the smart contract transaction from a second node of the plurality of nodes: identify an organization in the blockchain system associated with the second node; determine whether the organization is capable of executing the smart contract transaction indicated by the proposal; for the determination indicating that the organization does not have capability of executing the smart contract transaction indicated by the proposal, return an error to the second node; and for the determination indicating that the organization does have capability of executing the smart contract transaction indicated by the proposal, executing the smart contract transaction.

### BRIEF DESCRIPTION OF DRAWINGS

FIG. 1 shows an example system to implement in accordance with an example implementation.

FIG. 2 depicts an example implementation for a blockchain node.

FIG. 3 illustrates an example implementation for a block and a transaction proposal.

FIG. 4 illustrates an example implementation for organization information.

FIG. 5 shows an example implementation for private data information.

FIG. 6 and FIG. 7 present an example process of a blockchain client when a user starts the blockchain client to execute a transaction in the system, in accordance with an example implementation.

FIG. 8 illustrates an example process in the endorsing logic in a blockchain node, in accordance with an example implementation.

FIG. 9 illustrates an example process in the committing logic in a blockchain node, in accordance with an example implementation.

FIG. 10 illustrates an example process in the validation logic in a blockchain node, in accordance with an example implementation.

FIG. 11 illustrates another example system involving a blockchain-based system with an auditor.

FIG. 12 illustrates an example process of the auditing node, in accordance with an example implementation.

FIG. 13 illustrates another example system involving a blockchain-based system with the test platform.

FIG. 14 illustrates an example implementation for the test environment manager.

FIG. 15 illustrates an example process for the transform logic, in accordance with an example implementation.

FIG. 16 illustrates an example process for the test network launcher, in accordance with an example implementation.

FIG. 17 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

The blockchain technology provides immutable, distributed and trustful data store among multiple stakeholders. Although blockchain was started to realize cryptoassets, it has also been employed also by enterprise systems, especially ones in which multiple companies or organizations are involved. Most blockchain platforms for enterprise use employ simpler and conventional algorithms to reach a consensus among the participants on the data stored in the blockchain rather than novel but time-consuming algorithms such as PoW (Proof of Work), PoS (Proof of Stake), and PoET (Proof of Elapsed Time). The consensus algorithms for enterprise blockchain includes variations of CFT (Crash fault tolerance) and BFT (Byzantine fault tolerance), such as Paxos, RAFT and PBFT. They typically assume that when innocent participants execute a transaction, they should reach the same result. Therefore, for the transaction and result to be considered valid, the certain number of the participants should verify that they reach the identical result.

Blockchain can work well for the transactions when all the data involved are shared among the participants. However, while the blockchain technology accomplishes immutability and authenticity of the stored data by sharing the data publicly with the participants of blockchain network, enterprise use cases often require data that an organization cannot expose to other organizations. To fulfill such requirements, private data features are introduced in many enterprise blockchain platforms. In related art implementations, private data are stored in a certain part of the participants who are allowed to see the data, and the hash values of the data are stored in the blockchain to be made available to all the participants. Still such features have challenges to be solved when they are to be used in transactions which involve multiple private data.

To illustrate one of the challenges, suppose there are three organizations: A, B, and C. They maintain their own balances in bilateral private data. For example, B maintains two balances: one to share with A (“balance BA”) and the other to share with C (“balance BC”). When A and B execute a trade, the balances are mutually checked and the transaction for the trade will be verified by the two organizations: A and B. Then B may want to transfer some money from the balance BA to the balance BC to start a transaction that pays to C. Because B is the only organization which can see the two balances, the balances after the transaction can only be verified by B, which allows B to falsify the balances. No other organization can verify the correctness of the transaction because they only know the hash values for the balances and are not able to calculate how much is deducted from the first balance and is deposited to the second balance from their hash values. The root cause of this issue is that B is the single point of trust for the transaction.

Example implementations described herein are directed to providing systems based on enterprise blockchain with an increased number of points of trust for transactions in which private data are involved. One implementation is composed of: one or more organizations, one or more read-only organizations, one or more blockchain nodes in each organization and each read-only organization, network connecting the blockchain nodes which facilitate peer-to-peer communication among the nodes, and ordering service. The read-only organizations are configured to be eligible to access private data in other organizations so that they can verify transactions that involve multiple private data, especially when the number of organizations that can access all the private data is only one.

Each blockchain node in an organization, including the read-only organization, has endorsing logic that executes a smart contract according to a transaction proposal and returns the result with its endorsement, and committing logic that validates transactions with validating logic and persists the transaction in its local ledger. The endorsing logic performs a check before it goes to the execution of the smart contract if the proposal is sent from a read-only organization based on the identity in the proposal. If so, the endorsing logic rejects the proposal to ensure that no read-only organization proposes or makes transactions. The validating logic also has a check for the creator of the transaction even if the read-only organization manages to submit a transaction. It marks the transaction with “invalid” if the creator belongs to any read-only organization to ensure that the result of the transaction cannot be applied to the blockchain. By enforcing checks to prevent read-only organizations from performing transactions to modify the ledger, they can be more trustable and more appropriate to be a mediator or an auditor. Such implementations thereby allow other organizations allow the read-only organizations to access their private data.

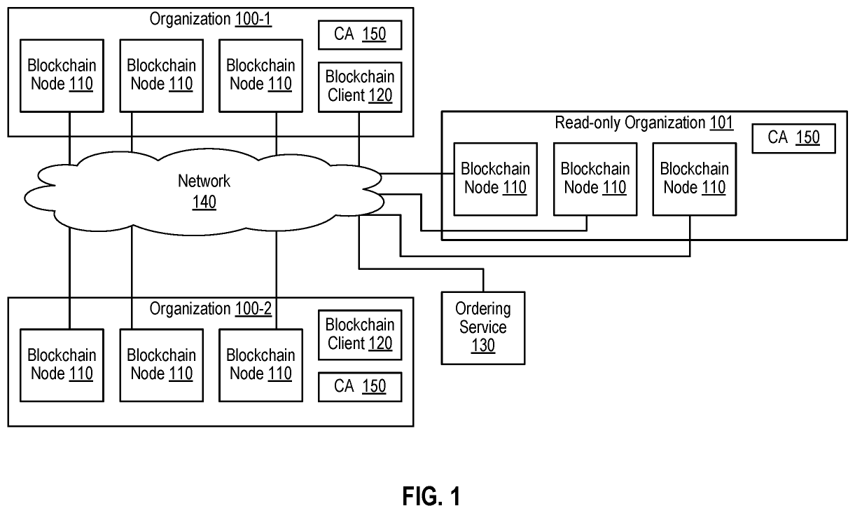

FIG. 1 shows an example system to implement in accordance with an example implementation. The system in FIG. 1 forms a consortium blockchain with known participants, which are grouped into multiple organizations. An organization can be a company, a department or a division, each independent enough to establish its own trust. The example of FIG. 1 shows two organizations 100-1 and 100-2 and one read-only organization 101. The number of organizations and the number of read-only organizations can be any number equal to or larger than one. A read-only organization 101 is a special type of organization, and has the same structures and logics as other organizations. The major difference is that members in a read-only organization are not allowed to invoke transactions, which make changes in data stored in the blockchain. An organization can have one or more blockchain nodes 110, one or more blockchain clients 120, and one or more certificate authorities (CAs) 150.

A blockchain node 110 is a computer that has computation capability, memory, persistent storage and communication capability via network. It can be a physical computer server, a virtual machine, a container, or any other form that has the similar capabilities to a computer to facilitate the desired implementation. As described herein, it persists ledger, state database, and private data, executes a smart contract (a program to which the participants agreed) according to a received transaction proposal, and validates and updates transactions after they get ordered by the ordering service 130.

The ordering service 130 is a service provided by one or multiple computers, which can be physical computers, virtual machines, containers, any other similar machines, in singular or in combination in accordance with the desired implementation. The ordering service 130 is responsible for deciding the full order of the transactions issued in the system, for creating the blocks each of which include the one or multiple transactions in the order decided, and for delivering the blocks to all the blockchain nodes 110. Blockchain client 120 and CA 150 are programs executed in a computer, which can be a physical computer, a virtual machine, a container or any other similar machine in accordance with the desired implementation. It may be executed in the same computer as any of the blockchain nodes 110, or may be executed in a separate computer. A blockchain client 120 initiates transactions by sending the transaction proposal to one or more of the blockchain nodes 110, and sending the responses as transactions to the ordering service 130, which in turn delivers the blocks that contain the transactions to the blockchain nodes 110. A read-only organization 101 does not have blockchain clients because it is not allowed to invoke transactions.

A CA 150 is a computer program which issues verifiable identities and can be executed in a physical computer, virtual machine, container, and so on, in accordance with the desired implementation. The CA 150 can use a cryptographic method such as issuing a digital certificate signed with the CA's private key with a cryptographic algorithm such as RSA and ECDSA. A CA 150 also has its own identity such as a digital certificate signed by itself or by another superior CA, the public key of which corresponds to the private key used for signing the certificates it issued. The blockchain nodes 110, the blockchain clients 120, the ordering service 130, and optionally CAs 150 are connected by the network 140 and can communicate with one another in a peer-to-peer fashion. The network 140 can be a local area network (LAN), wide area network (WAN), or virtual private network (VPN), and can be wired or wireless depending on the desired implementation. The communication between them can be encrypted and/or secured, for example, by using Transport Layer Security (TLS).

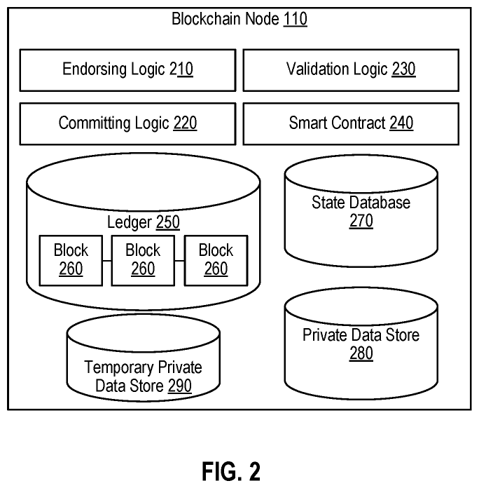

FIG. 2 depicts an example implementation for a blockchain node 110. Blockchain node 110 can include executable programs such as endorsing logic 210, committing logic 220, validation logic 230, and a smart contract 240. It has persistence storage that stores ledger 250, state database 270, private data store 280, and temporary private data 290. The endorsing logic 210 implements the endorsing phase of the consensus. The committing logic 220 implements the validation phase of the consensus, and it internally calls the validation logic 230 for the core of the validation of the transaction. The smart contract 240 is a program that defines the behavior of the transactions, and calculates the result based on the current data stored in the ledger. The smart contract 240 defines several functions which optionally take one or multiple parameters, and the blockchain client 120 sends a transaction proposal specifying the identifier of one of the functions and the parameter(s) if any. The details for the logics are disclosed in other figures below.

The data shared in the system is stored in the ledger 250. The data is stored as a chain with the blocks 260. The state database 270 is a snapshot of the latest version of data in the ledger 250. Because each transaction in the block 260 typically only has information for the values that are involved in the transaction, the blockchain node 110 maintains and updates the snapshot of the latest state after every valid transaction is committed to obtain the latest state. The private data store 280 holds private data that is not to be shared outside of specified organizations. The private data is stored in the private data store 280 and generally has the same data model as the non-private data (e.g., public data stored in the ledger 250 and the state database 270). A transaction contains values for the non-private data, and hashes of the values for the private data. There can be multiple private data stores 280, so that the blockchain node 110 can have different data stores, each of which involving different set of organizations that are granted access.

The temporary private data store 290 holds private data that are not committed yet. Private data are written to the private data store 280 once the transaction involving the data is committed. In the endorsement phase, when the endorsement logic 210 invokes the smart contract 240 upon receiving a transaction proposal 370 involving private data from the blockchain client 120, the smart contract 240 returns the result including values for the private data as well as for the non-private data. Due to their nature, the values of the private data cannot be shared with all the participants, and the endorsement logic 210 does not return the values for the private data but the hashes of the values. Because there is a need to hold the new values for the private data until it is committed in the validation phase, the endorsement logic 210 stores private data in the temporary private data store 290. Once the transaction is validated in the validation phase, the committing logic 220 updates the state database 270 for the non-private data, and updates the private data store 280 for the private data.

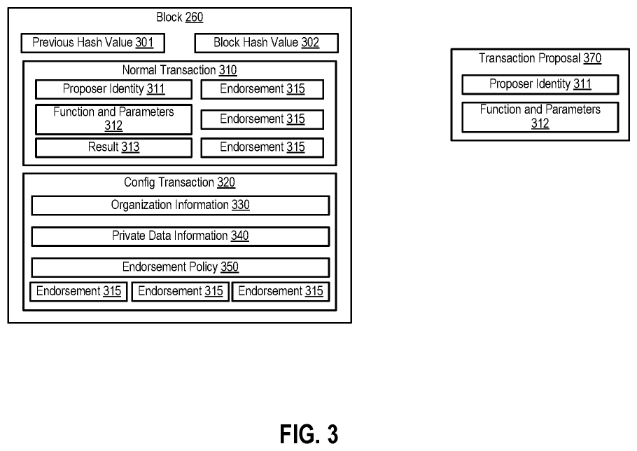

FIG. 3 illustrates an example implementation for a block 260 and a transaction proposal 370. Blocks 260 are connected linearly to one another with hash values. Hash values are values obtained by a one-way function such as SHA-1, SHA-256 and MDS. Previous hash value 301 is a hash value for the previous block. Block hash value 302 is a hash value for the block itself 260. Both hash values may be calculated for the whole bytes of the target block or the bytes of some portion of the target block, such as the header part of the block depending on the desired implementation. A block 260 contains one or more transactions which can involve multiple types of transactions. The example of FIG. 3 illustrates two types of transactions: a normal transaction 310 and a config transaction 320. A normal transaction 310 is a transaction which changes data as a result from invoking a smart contract 240. A config transaction 320 is a transaction which changes the configuration of the system. The blockchain node 110 can store the current configuration and configuration history in a separate ledger and state database.

A normal transaction 310 has the proposer identity 311, the function and parameters 312, the result 313, and one or more endorsements 315. The proposer identity 311 contains information to identify the entity which requested the transaction, or that sent the transaction proposal 370. The proposer identity 311 can contain a certificate issued for the blockchain client 120 and a digital signature for the contents of the transaction.

The function and parameters 312 represent the name or identifier of the function and the parameters that are used to execute a smart contract 240. The result 313 contains the result obtained by executing the smart contract 240 with the function and parameters 312. The result 313 can contain identifiers such as addresses and keys of the data in the ledger 250 with their respective new values. The result 313 can have the old values or the values read during execution of the smart contract to detect conflicts with other transactions by comparing the values read with the latest values in the validation phase to prevent read-after-write (RAW) data hazards. The result 313 can have the versions of the old values or the values read instead of their actual values. When private data is used, the result 313 may contain values for non-private data as well as hashes for values for private data. The endorsements 315 contain verifiable evidence that blockchain nodes 110 have agreed to obtain the result 313 by executing the smart contract 240 with the function and parameters 312. For example, an endorsement can include a digital signature for the result 313 using the private key of a blockchain node 110 and an identity of the entity, specifically the blockchain node 110 that created the signature.

A config transaction 320 contains the organization information 330, private data information 340, endorsement policy 350, and one or multiple endorsements 315. The organization information 330 contains information for an organization which participates in the blockchain system, i.e. in the consortium. The private data information 340 contains information for private data if any. The endorsement policy 350 defines a condition for endorsements for a transaction to comply with. Only when the endorsements in a transaction satisfy the condition, the transaction is considered valid. One example for the condition is a minimum number of different organizations which gave endorsements. The other example is an AND-OR tree of organizations which gave endorsements such as “Organization A AND (Organization B OR Organization C)”. It may define different conditions for normal transactions 310 and for config transactions 320. A config transaction 320 may have all the information described above or may have the difference of the information for which the transaction is going to apply, depending on the desired implementation.

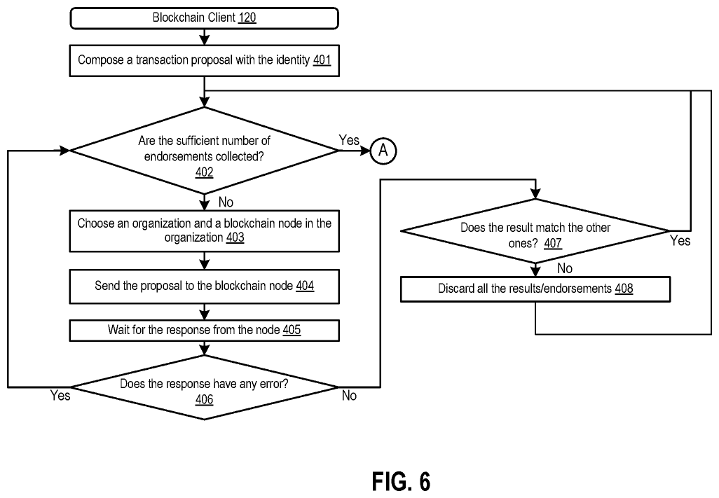

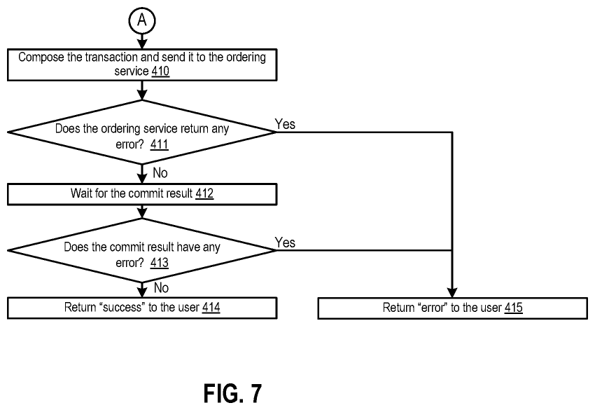

A transaction proposal 370 is sent from the blockchain client 120 to the blockchain nodes 110 in order to request execution of the smart contract 240 during the endorsement phase. It contains the proposer identity 311 and the function and parameters 312 for the smart contract to be invoked in the transaction. As described in FIGS. 6 and 7, the contents in the transaction proposal are copied to a normal transaction 310 and sent to the ordering service 130 during the ordering phase. Transaction proposals for the config transaction 320 may have a different structure; they may have all or some portion of organization information 330, private data information 340 and endorsement policy 350 depending on the desired implementation.

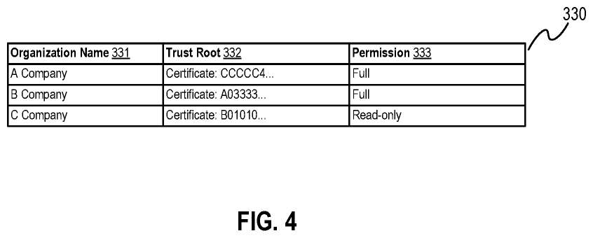

FIG. 4 illustrates an example implementation for organization information 330. The information contains an organization name 331, trust root 332, and permission 333 for each organization. The organization name 331 for each organization is an identifier for each organization, and can be, for example, “Company A”, “Company B” and so on. A proposer identity 311 or an identity in an endorsement 315 may include the organization name 331 as the part of the identity. Trust root 332 for each organization is information used to verify the identity 311 of the entity that claims to belong to the organization. One example for trust root 332 is a self-signed certificate of the CA 150 in the organization. When the blockchain clients 120 in the organization use certificates that are issued by the CA 150 and signed with the key pair corresponding to the self-signed certificate as the proposer identity 311 in transaction proposals 370, the endorsing logic 210 and the validation logic 230 can verify the certificates by checking if the signatures in the certificates are correct with the public key in the self-signed certificate. Another example is a certificate issued for the CA 150 by another CA, which can be a publicly known and trusted one. The key pair corresponding to the certificate should be used for the signatures also in this case. The permission 333 for each organization defines capability of the organization, whether it is allowed to initiate and propose transactions in the system. For example, when the permission 333 for an organization is “all”, then the organization is an organization 100 which is able to initiate transactions, and when the permission 333 is “read-only”, then the organization is a read-only organization 101 which is not able to initiate transactions.

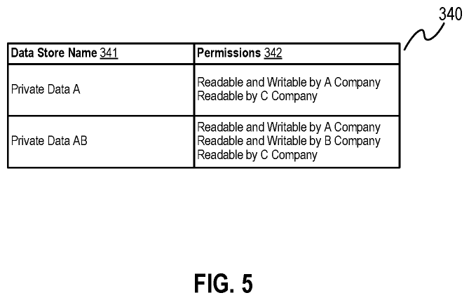

FIG. 5 shows an example implementation for private data information 340. The information contains a data store name 341 and permissions 342 for each private data store. The data store name 341 is the identifier for a private data store, and can be, for example, “Private Data A”, “Private Data AB”, and so on. The permissions 342 are the list of permissions that specifies the allowed access from organizations to the data in the private data store. An example of the permissions 342, as depicted in the figure, is “Readable and Writable by A Company”, which means that the private data store can be read and written by the blockchain nodes 110 in the organization “A Company”. As the private data store is accessed by the smart contract 240 in the endorsement phase, the permissions are given to the blockchain nodes 110.

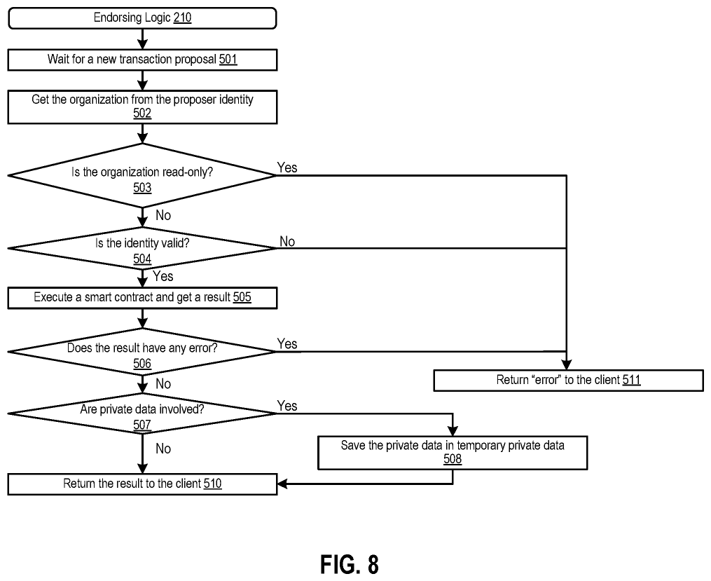

FIG. 6 and FIG. 7 present an example process of a blockchain client 120 when a user starts the blockchain client 120 to execute a transaction in the system, in accordance with an example implementation. First, the blockchain client 120 composes a transaction proposal 370 using its identity (Step 401). The transaction proposal 370 contains the proposer identity, (i.e. the identity of the blockchain client 120 such as the digital certificate issued by the CA 150 in the same organization as the blockchain client 120 and the signature created with the key pair corresponding to the digital certificate), and the function and parameters to invoke the smart contract. Then, the blockchain client 120 loops until it gets the sufficient number of endorsements (Step 402) as follows: At 403, the blockchain client 120 chooses an organization to send the proposal 370 to obtain an endorsement, and a specific blockchain node 110 belonging to the organization. The blockchain client 120 can choose an organization according to several criteria such as whether or not it already obtained an endorsement from any blockchain node 110 in the organization, and whether or not the organization can access the private data involved in the transaction proposal 370. It also may use several criteria to choose a blockchain node 110 such as the number of the blocks received by the blockchain node, and the load of the blockchain node. After it chooses the organization and the blockchain node 110, the blockchain client 120 sends the proposal 370 to the blockchain node 110 (Step 404). The proposal 370 is received and processed by the endorsing logic 210 in the blockchain node 110 as described later in FIG. 8. Then it waits for the response from the blockchain node 110 (Step 405). The response indicates whether the process of the endorsing logic finished successfully or not, and it contains the result from the smart contract 240 and the endorsement from the blockchain node 110 if it was successful. If it failed, then the blockchain client 120 goes back to the step 403 so that it can try to send the proposal 370 to either the same blockchain node 110 or another blockchain node 110.

At step 406, when the proposal 370 is successful (No), the blockchain client 120 compares the result with the previous results it obtained from other blockchain nodes 110 for the same proposal 370 at step 407. If they are identical (Yes), then the blockchain client 120 keeps the result and the new endorsement, and goes back to the step 402. Otherwise (No), as the blockchain nodes 110 cannot reach the consensus on the result of the transaction proposal 370, the blockchain client 120 discards all the endorsements it obtained, and starts again from the step 402. The steps 401-408 form the endorsement phase in the three-phase consensus of the blockchain system. Once the endorsement(s) obtained are sufficient, the blockchain client 120 switches to the next step (Step 402:Yes).

At 410, the blockchain client 120 composes a normal transaction 310 with the proposer identity 311, the function and parameters 312, the result 313 and the accumulated endorsement(s) 315, and it sends the transaction to the ordering service 130. At step 411, if it encounters an error (Yes), it returns the error to the user (Step 415). Otherwise (No), after it receives a transaction, the ordering service 130 determines the order of transactions it received from the organizations, and creates blocks, each involving one or more transactions, and delivers them to the blockchain nodes 110. This forms the ordering phase in the consensus. The blockchain client 120 waits for the result of the validation phase from any of the blockchain nodes 110 at step 412. If the result indicates an error or that the transaction is considered invalid (Yes), the blockchain client 120 returns the error to the user at step 415. Otherwise (No i.e. the result is successful) the transaction is considered valid, the blockchain client 120 returns the success to the user at step 414. Optionally, the blockchain client 120 returns the result from the smart contract 240 for the user to know the new values depending on the desired implementation.

FIG. 8 illustrates an example process in the endorsing logic 210 in a blockchain node 110, in accordance with an example implementation. The endorsing logic 210 waits for a new transaction proposal 370 from any blockchain client 120 (Step 501). Then it gets the organization to which the proposer belongs by using the proposer identity 311 (Step 502). Referring to the organization information 330, the endorsing logic 210 checks if the organization is read-only or not (Step 503). If it is read-only (Yes), the endorsing logic 210 returns an error to the blockchain client 120 (Step 511). If it is not (No), the endorsing logic 210 performs further checks that the identity is correct (Step 504).

The checks include if the certificate is issued by the CA 150 and if the signature for the transaction proposal 370 is correct. If the checks fail (No), the endorsing logic 210 returns the error to the blockchain client 120 (Step 511). Otherwise (Yes), the endorsing logic 210 executes the smart contract 240 according to the function and parameters in the transaction proposal 370 (step 505).

At Step 506, if the smart contract fails (Yes), the endorsing logic 210 returns the error to the blockchain client 120 (Step 511). If the smart contract returns the result successfully (No), the endorsing logic 210 checks if the result contains any private data (Step 507). If it contains private data (Yes), the endorsing logic 210 stores the private data into the temporary private data store 290 (Step 508). The endorsing logic 210 removes the private data from the result, and adds the hash values for the private data instead in case the smart contract did not calculate them. Finally, the endorsing logic 210 returns the result as well as the endorsement for the result to the blockchain client 120 (Step 510).

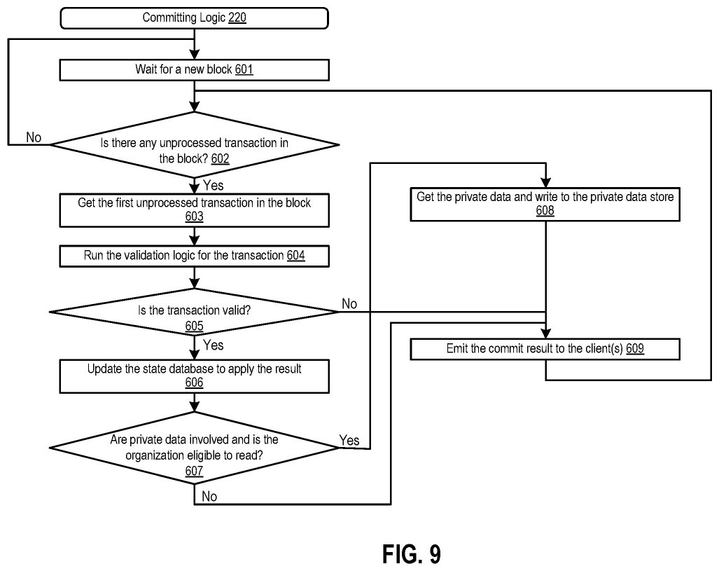

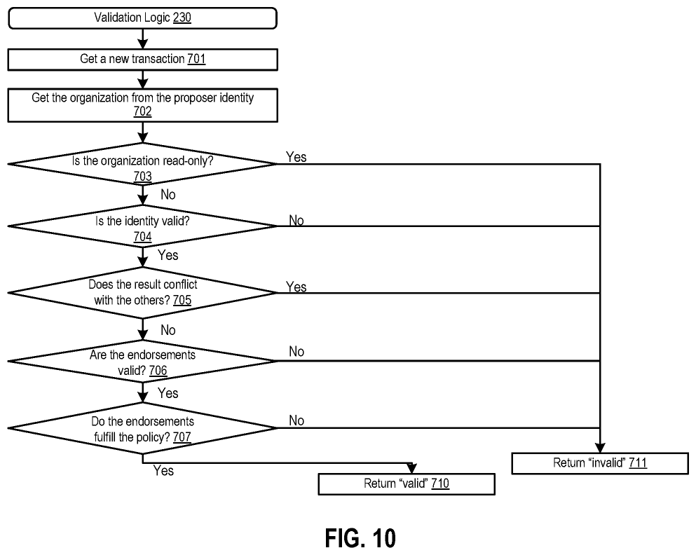

FIG. 9 illustrates an example process in the committing logic 220 in a blockchain node 110, in accordance with an example implementation. The committing logic 220 waits for a new block from the ordering service 130 (Step 601). Then it traverses the transactions in the block and commits the transactions one by one. First, it checks if the block has any transaction that was not committed (Step 602), and if any (Yes), it gets the first transaction that was not committed in the order specified in the block, which was determined by the ordering service 130 (Step 603). Next, the committing logic 220 executes the validation logic 230 for the transaction (Step 604), which is described later in FIG. 10. If the result is valid (Step 605: Yes), the committing logic 220 updates the state database 270 to apply the result of the transaction (Step 606).

If the private data is involved in the transaction, and the organization is permitted to read the private data according to the permissions 342 for the private data (Step 607: Yes)), it gets the actual values for the private data, either from the temporary private data store 290 or from the other blockchain node 110 that has the private data (Step 608). Methods to achieve the latter implementation include peer-to-peer communication protocols such as gossip.

After the committing logic 220 obtains the values, it updates the private data store 280 as per them. If the validation result is invalid (Step 605:No), the committing logic 220 skips updating the state database 270 and the private data store 280. Finally, the committing logic 220 emits the result of the commitment for the transaction, including the validity of the transaction, to the blockchain clients 120 if there are any listening to (Step 609). Step 609 may be executed for each transaction, for each block, aggregating the results for the transactions, or for multiple blocks, in order to optimize the communication. It goes back to Step 602 and repeats until all the transactions are consumed. The committing logic is distributed and executed in each blockchain node 110. Because they have the same blocks in the ledger and the same logic, it is ensured that the committing logics 220 in all the blockchain nodes 110 obtain the same result.

FIG. 10 illustrates an example process in the validation logic 230 in a blockchain node 110, in accordance with an example implementation. It is called by the committing logic 220 when there is a transaction to commit. First, it gets the transaction (Step 701), and gets the organization from the proposer identity 311 (Step 702). The validation logic 230 then executes a sequence of checks (Step 703). It checks whether or not the organization is read-only. This cannot happen in the normal procedure because the endorsing logic 210 does not allow the read-only organization to propose transactions; however, this can happen in some corner cases such as just after changing the permission of the organization to read-only. The check ensures that the transaction proposed by a read-only organization never takes effect even if it is to be committed. Next (Step 704), the validation logic 230 checks if the proposer identity 311 is valid or not, like Step 504. It then checks if the transaction does not conflict any other transaction committed before (Step 705). For example, it can compare the latest values at the time of validation with the values read at the time of endorsement contained in the result 313. If they are different, it means that there exists some other transaction involving the same data that was committed after the transaction is endorsed and before the transaction is about to commit, therefore the transaction cannot be considered valid. The validation logic 230 then checks if the endorsements are valid or not (Step 706). The checks include whether or not the signature in each endorsement is generated for the result 313 and the identity is valid. Finally, the validation logic 230 checks if the endorsements fulfill the endorsement policy 350 (Step 707). When the transaction passes all the checks, the validation logic 230 returns “valid” to the committing logic 220 (Step 710). Otherwise, the validation logic 230 returns “invalid” to the committing logic 220 (Step 711).

With the first example implementation described above, the blockchain system can have two types of the organizations: organizations with the full permission and read-only organizations. The endorsing logic and the validation logic ensure that any transaction proposed by any entity in read-only organizations are rejected or marked invalid. On the other hand, the blockchain nodes in read-only organizations are able to endorse transactions. When these read-only organizations are allowed to read the private data, they add more chances to get multiple endorsements for transactions including the private data, and therefore it alleviates the SPoT issue regarding the private data. The limitation that the read-only organizations cannot perform transactions encourages the other organizations to trust them as neutral third-parties, and would increase chances to expose their private data to get their endorsements.

The example may be extended for the system to always allow the read-only organization to read any private data. This is equivalent to implicitly adding “read by the read-only organizations” to the permissions for every private data.

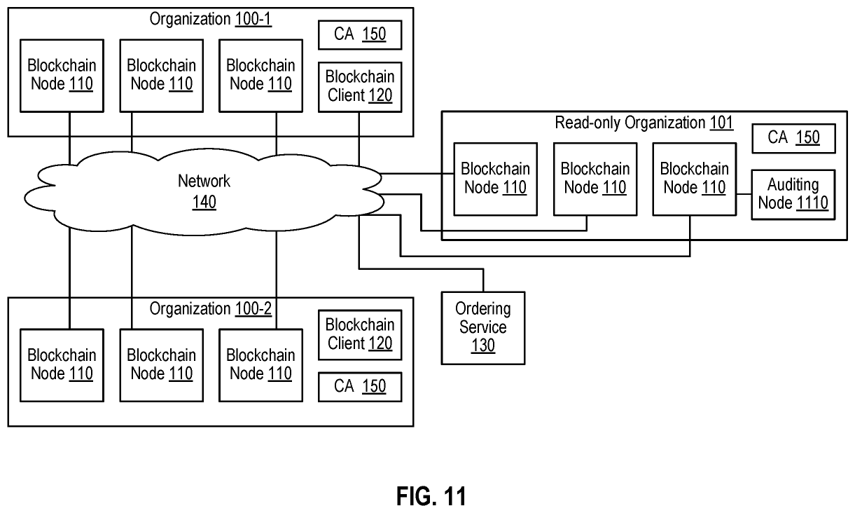

In a second example implementation, FIG. 11 illustrates another example system involving a blockchain-based system with an auditor. The components work similarly to those in FIG. 1 in the first example implementation. In this example, one read-only organization serves as an auditor for the system. Thus, the read-only organization 101 has one or more auditing nodes 1110 that are connected with one or multiple blockchain nodes 110 by network 140 or any other network internal to the read-only organization 101. An auditing node 1110 performs various checks on the data for the auditing purpose. An auditing node 1110 retrieves the information of the data shared in the system, i.e. blocks and transactions from the blockchain nodes 110. It may be a physical computer, a virtual machine or a container, or may be the same machine as one of the blockchain nodes 110. The descriptions for the example implementations and the execution flows for the components in FIG. 11 except the auditing node 1110 are omitted here because they are identical to those disclosed in the first example implementation. It should be added, however, to the blockchain node 110 a feature that allows the auditing node 1110 to refer to the ledger and the private data. One implementation is to expose functions or application programming interfaces (APIs) that can be accessed by the auditing node 1110 and return the blocks, transactions, and private data as per the requests from the auditing node 1110. Another implementation is to have the blockchain node 110, namely the committing logic 220, forward the blocks, transactions, and private data to the auditing node 1110 after it commits them. Other implementations include one that the auditing node 1110 directly receives the blocks from the ordering service 130 and the private data from one of the blockchain nodes 110.

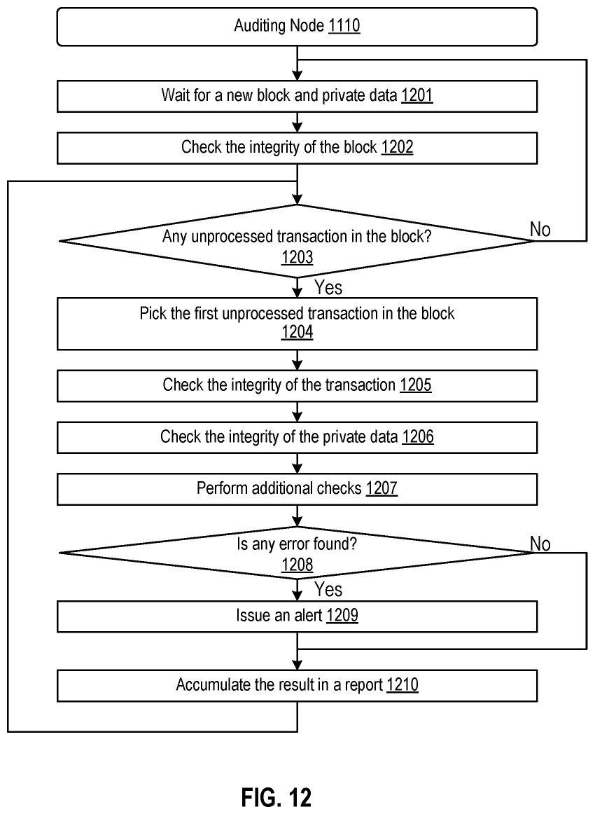

FIG. 12 illustrates an example process of the auditing node 1110, in accordance with an example implementation. First, it waits for a new block and private data relevant to the transactions in the block by means some examples of which are described in the last paragraph (Step 1201). Then it checks integrity of the block (Step 1202). The checks include verification of hash values 301 and 302 against the actual data of the previous block and the current block. Then it iterates checks for each unprocessed transaction in the block (Step 1203:Yes) in the stored order of the transaction (Step 1204). It checks integrity of the transaction (Step 1205) and the private data (Step 1206) if any. The integrity of the transaction includes the signatures in the proposer identity 311 and the endorsements 315, and the integrity of the private data includes the hashes in the result 313 matching to the actual private data. It may perform additional checks (Step 1207), for example, it may check if balance of one account is consistent with the other accounts, or it may check any suspicious activities such as money laundering, or otherwise in accordance with the desired implementation. If any error is found in the checks (Step 1208), it may issue an alert depending on the severity of the error (Step 1209). Then, it accumulates the results in a report (Step 1210), which can be generated for each transaction, for each block, or for each certain period.

In this second example implementation, as a trusted third-party organization, the read-only organization can audit the blockchain-based system. In addition to verifying the integrity of the blockchain, the read-only organization can perform various checks recommended or mandated by regulations, laws, etc. based on the verified immutability. It contributes to make auditing more robust and efficient.

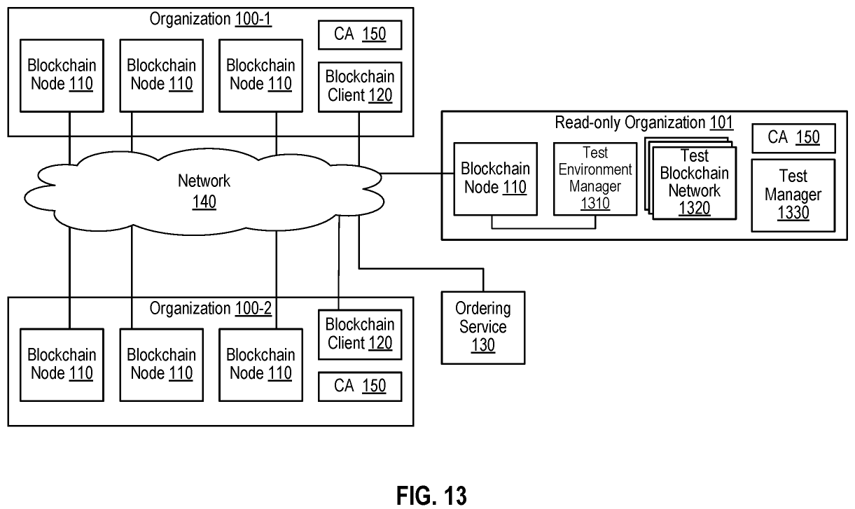

In a third example implementation, FIG. 13 illustrates another example system involving a blockchain-based system with the test platform. The components work similarly to those in FIG. 1 in the first example implementation. The blockchain network, involving the organizations 100-1 and 100-2, the read-only organization 101 and the ordering service 130 as well as the blockchain nodes 110, the blockchain client 120 and the CA 150 in each organization, is referred to by “production blockchain network” or “production environment” below.

In this example, one read-only organization provisions a test environment for the system. To test blockchain-based systems during the development and before the deployment, it can be desirable to use the same data as in the real system. For updates of the existing systems, the ledger in the existing system is a promising candidate for the data to be used in the test environment to achieve more practical and effective tests. However, the cryptographic materials, such as public keys and private keys, are not available and should not be used for the test environment because signatures by the materials in the test environment can have the same effect and implications as in the production environment. Moreover, the private data are also necessary, but are not included in the ledger. In this example, the read-only organization can provide test environments with the data extracted from the existing blockchain system, with the necessary conversion for cryptographic materials and relevant information, and with the private data of all the organizations.

The test environment manager 1310 converts blocks, transactions and private data properly, and generates and destroys blockchain network for testing purposes using the converted data. It can be a physical computer, a virtual machine, a container, etc. and its hardware can be shared with other components. It can communicate with the blockchain node 110 using the network 140 or other network internal to the read-only organization 101. It obtains blocks and private data in the manner shown in the second example implementation. The test blockchain networks 1320 are blockchain-based systems generated and configured by the test environment manager 1310. They have structures that are the same as or similar to FIG. 1 because their purpose is to test new software in the environments that are as similar as possible to the production environment. The major difference would be all the organizations in the test blockchain networks are managed by the read-only organization 101 because they are built just for testing performed by the read-only organization 101. The number of the nodes in each organization in the test blockchain networks may differ from that in the organization in FIG. 13, depending on the test cases and the resources available for the tests. The test manager 1330 manages the tests; it directs the test environment manager 1310 to create a new test network before it is to perform tests, and performs tests in the test blockchain network 1320. The test manager 1330 can be a physical computer, a virtual machine, a container, etc., and its hardware can be shared with other components. The software of the test manager 1330 can be a part of automated testing tools for CI (Continuous Integration), which trigger tests when changes are made into the repository of the source code of the system.

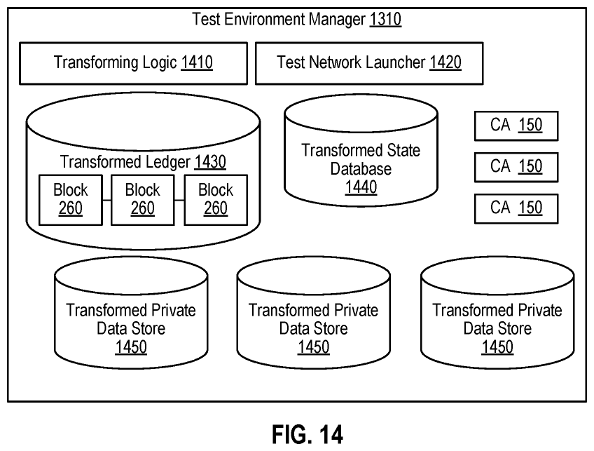

FIG. 14 illustrates an example implementation for the test environment manager 1310. The test environment manager 1310 has two logics: the transforming logic 1410 and the test network launcher 1420. The transforming logic 1410 receives the blocks and the private data either from the blockchain node 110 in the read-only organization 101, from the ordering service 130, and transforms the blocks and the private data into those that are appropriate to be used in the test blockchain networks 1320. It accumulates the transformed data in the transformed ledger 1430, the transformed state database 1440 and the transformed private data stores 1450, which are later used by the test network launcher 1420 to generate a new blockchain network 1320. The test network launcher 1420 generates a new blockchain network 1320 upon a request. It uses the transformed data to initialize the test blockchain network 1320 so that it starts with the same state as the production blockchain network, and the test manager 1330 can perform more realistic tests using the production data. For transformation, it uses its own CAs 150 to generate certificates and signatures, because the private keys for the CAs 150 in the organizations in the production environment are not available to the read-only organization 101. The transformed ledger 1430, the transformed state database 1440 and the transformed private data store 1450 correspond to the ledger 250, the state database 270 and the private data store 280 in FIG. 2 respectively. The structures of these components are identical but intended to store the transformed data. To create mockups of the organizations in the production environment, the test environment manager 1310 maintains multiple CAs 150 and transformed private data store 1450 so that each of them corresponds to a mockup organization.

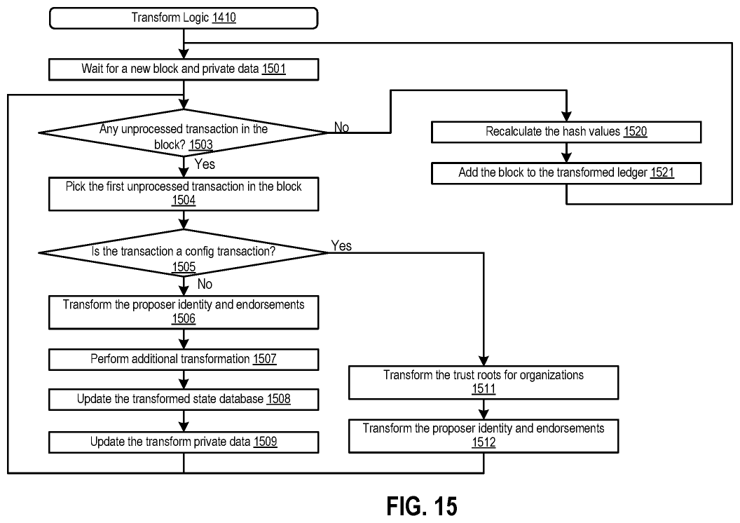

FIG. 15 illustrates an example process for the transform logic 1410, in accordance with an example implementation. First, it waits for a new block and private data relevant to the transactions in the block (Step 1501). It iterates the following transformation over the unprocessed transactions in the block (Steps 1503 and 1504). If a transaction is a normal transaction (Step 1505:No), then it transforms the proposer identity 311 and the endorsements 315 (Step 1506). The transformation includes replacing the certificates in the identity and the endorsements with those issued by the CAs 150 in the test environment manager 1310 and replacing the signatures with ones generated by the private keys corresponding to the replaced certificates. Optionally, the transform logic 1410 can perform additional transforms (Step 1507) such as anonymization of the data in the transaction in case there is any concern for using the same data for testing. If the result 313 or any data is transformed at Step 1507, the signatures may be calculated again. Then if the transaction is valid, it updates the transformed state database 1440 to apply the result of the transaction as done in Step 606 (Step 1508). If the transaction is valid and involves any private data, it updates the transformed private data stores 1450 properly (Step 1509).

If a transaction is a config transaction (Step 1505: Yes), the transform logic 1410 transforms the trust roots 332 for the organizations in the organization information 330 in the transaction (Step 1511). Because different CAs will be used in the test blockchain network 1320 and the certificates in the trust roots should be different from those in the trust roots 332 in the production environment, the trust roots 332 should be replaced with the certificates for the CAs 150 in the test environment manager 1310. Then, the transform logic 1410 transforms the proposer identity and the endorsements like Step 1506 (Step 1512).

When all the transactions in the block are transformed (Step 1503:No), the transform logic 1410 calculates the hash value for the block and replaces the block hash value 302 with the new value. At step 1520, it also replaces the hash value for the previous block 301 with that for the previous block in the transformed ledger 1430. Finally, the transform logic 1410 adds the transformed block into the transformed ledger 1430 (Step 1521).

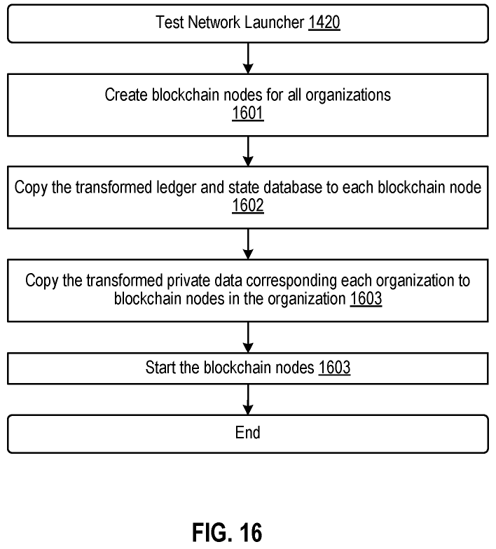

FIG. 16 illustrates an example process for the test network launcher 1420, in accordance with an example implementation. Upon a request from the test manager 1330, it creates new blockchain nodes 110 for all the organizations and read-only organizations (Step 1601). Instead of starting the nodes with empty ledgers and database, it copies the transformed ledger 1430 and state database 1440 to each blockchain node (Step 1602). For efficiency, it can use several features in the persistent device where the transformed ledger 1430 and state database 1440 are stored, such as snapshots and zero-copy cloning. Then it copies the transformed private data stores 1450 to the blockchain nodes in the proper organization (Step 1603). Finally, the test network launcher 1420 starts the blockchain nodes 110 (Step 1604) and passes the information to the test manager 1330 so that it can perform tests with the newly created blockchain network.

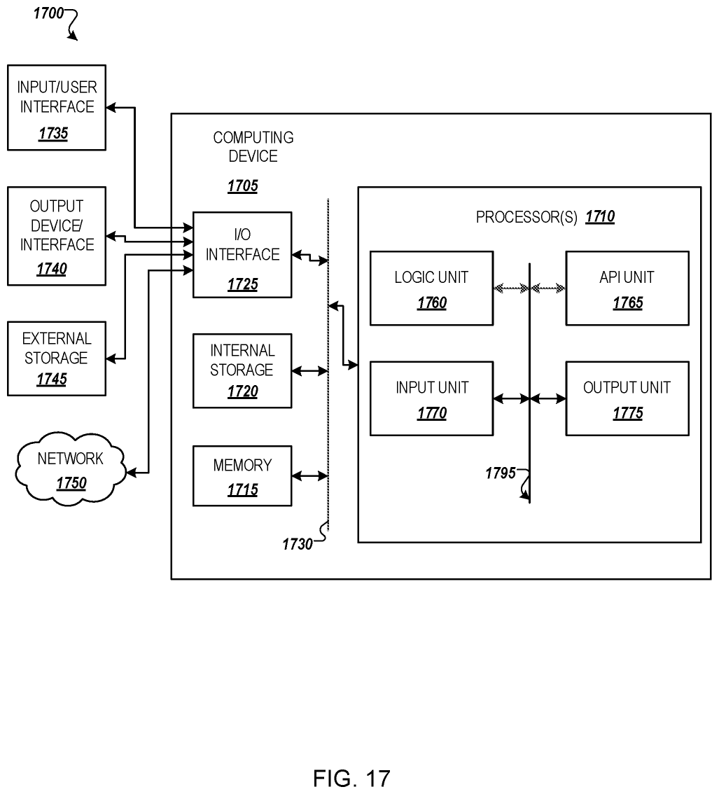

FIG. 17 illustrates an example computing environment with an example computer device suitable for use in some example implementations, such as an apparatus to facilitate any node, test environment manager, organization, ordering service, and so on in the blockchain system as described herein. Computer device 1705 in computing environment 1700 can include one or more processing units, cores, or processors 1710, memory 1715 (e.g., RAM, ROM, and/or the like), internal storage 1720 (e.g., magnetic, optical, solid state storage, and/or organic), and/or 10 interface 1725, any of which can be coupled on a communication mechanism or bus 1730 for communicating information or embedded in the computer device 1705. IO interface 1725 is also configured to receive images from cameras or provide images to projectors or displays, depending on the desired implementation.

Computer device 1705 can be communicatively coupled to input/user interface 1735 and output device/interface 1740. Either one or both of input/user interface 1735 and output device/interface 1740 can be a wired or wireless interface and can be detachable. Input/user interface 1735 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1740 may include a display, television, monitor, printer, speaker, braille, or the like. In some example implementations, input/user interface 1735 and output device/interface 1740 can be embedded with or physically coupled to the computer device 1705. In other example implementations, other computer devices may function as or provide the functions of input/user interface 1735 and output device/interface 1740 for a computer device 1705.

Examples of computer device 1705 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1705 can be communicatively coupled (e.g., via IO interface 1725) to external storage 1745 and network 1750 for communicating with any number of networked components, devices, and systems, including one or more computer devices of the same or different configuration. Computer device 1705 or any connected computer device can be functioning as, providing services of, or referred to as a server, client, thin server, general machine, special-purpose machine, or another label.

IO interface 1725 can include, but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 1700. Network 1750 can be any network or combination of networks (e.g., the Internet, local area network, wide area network, a telephonic network, a cellular network, satellite network, and the like).

Computer device 1705 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1705 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1710 can execute under any operating system (OS) (not shown), in a native or virtual environment. One or more applications can be deployed that include logic unit 1760, application programming interface (API) unit 1765, input unit 1770, output unit 1775, and inter-unit communication mechanism 1795 for the different units to communicate with each other, with the OS, and with other applications (not shown). The described units and elements can be varied in design, function, configuration, or implementation and are not limited to the descriptions provided. Processor(s) 1710 can be in the form of hardware processors such as central processing units (CPUs) or in a combination of hardware and software units.

In some example implementations, when information or an execution instruction is received by API unit 1765, it may be communicated to one or more other units (e.g., logic unit 1760, input unit 1770, output unit 1775). In some instances, logic unit 1760 may be configured to control the information flow among the units and direct the services provided by API unit 1765, input unit 1770, output unit 1775, in some example implementations described above. For example, the flow of one or more processes or implementations may be controlled by logic unit 1760 alone or in conjunction with API unit 1765. The input unit 1770 may be configured to obtain input for the calculations described in the example implementations, and the output unit 1775 may be configured to provide output based on the calculations described in example implementations.

The blockchain system is configured to facilitate a smart contract transaction through a plurality of nodes. In an example for a first node (e.g., any node of the plurality of nodes in the blockchain) processor(s) 1710 is configured to, responsive to receiving a proposal for the smart contract transaction from a second node of the plurality of nodes, identify an organization in the blockchain system associated with the second node; determine whether the organization is capable of executing the smart contract transaction indicated by the proposal; for the determination indicating that the organization does not have capability of executing the smart contract transaction indicated by the proposal, return an error to the second node; and for the determination indicating that the organization does have capability of executing the smart contract transaction indicated by the proposal, executing the smart contract transaction as illustrated in FIG. 8.

In an example of a first node, processor(s) 1710 is configured to determine whether the organization is capable of executing the smart contract transaction indicated by the proposal by determining that the organization is indicative of not having the capability of executing the smart contract transaction indicated by the proposal for the organization being a read-only organization; and determining that the organization is indicative of having the capability of executing the smart contract transaction indicated by the proposal for the organization not being a read-only organization as illustrated at FIG. 4 and proposer identity 311.

In an example of a first node, processor(s) 1710 is configured to, responsive to receiving a request for committing and validating the smart contract transaction from the second node (e.g., another node coupled to the first node), identify the organization in the blockchain system associated with the second node; determine whether the organization is capable of executing the smart contract transaction indicated by the proposal; for the determination indicating that the organization does not have capability of executing the smart contract transaction indicated by the proposal, return an error to the second node; and for the determination indicating that the organization does have capability of executing the smart contract transaction indicated by the proposal, execute an order of transactions provided by an ordering service as illustrated in FIG. 10.

In an example for ordering service 130, processor(s) 1710 can be configured to determine an order for executing the request for committing the smart contract transaction from second nodes with other requests for committing smart contract transactions; and provide the order to the first node as illustrated in FIG. 1 as an example.

In an example of a third node such as an auditing node 1110, processor(s) 1710 configured to execute an auditing process, the auditing process involving receiving the smart contract transaction and private data associated with the smart contract transaction; and executing integrity checks on the smart contract transaction and the private data as illustrated in FIG. 12.

In an example of an apparatus belonging to the read-only organization 101, processor(s) 1710 configured to, for receipt of an initiation of a test environment replace an identity of the organization in the blockchain system that initiated the proposal in the smart contract transaction and endorsements with the identity and endorsements issued by a test environment manager managing the test environment; and for the smart contract transaction indicative of a change in a configuration of the system, transform trust roots for organizations in the blockchain system indicated by organization information in the smart contract transaction as illustrated at FIG. 15.

In an example of such an apparatus belonging to the read-only organization 101, processor(s) 1710 is configured to launch a new blockchain network on the test environment, the launch facilitated by a test network launcher, the launch comprising copying a ledger transformed by the test environment manager and a state database transformed by the test environment manager to each blockchain node in the new blockchain network; and copying private data transformed by the test environment manager corresponding to organizations in the blockchain system associated with the smart contract transaction to the each blockchain node in the new blockchain network corresponding to the organizations as illustrated in FIG. 16.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for a blockchain system configured to facilitate a smart contract transaction, the blockchain system comprising a plurality of nodes, the method comprising:
responsive to receiving, at a first node from the plurality of nodes, a proposal for the smart contract transaction from a second node of the plurality of nodes:
identifying, at the first node, an organization in the blockchain system associated with the second node;
determining, at the first node, whether the organization is capable of executing the smart contract transaction indicated by the proposal;
for the determining indicating that the organization does not have capability of executing the smart contract transaction indicated by the proposal, returning an error to the second node; and
for the determining indicating that the organization does have capability of executing the smart contract transaction indicated by the proposal, executing the smart contract transaction.

2. The method of claim 1, wherein the determining, at the first node, whether the organization is capable of executing the smart contract transaction indicated by the proposal comprises:
determining that the organization is indicative of not having the capability of executing the smart contract transaction indicated by the proposal for the organization being a read-only organization; and
determining that the organization is indicative of having the capability of executing the smart contract transaction indicated by the proposal for the organization not being a read-only organization.

3. The method of claim 1, further comprising, responsive to receiving, at the first node, a request for committing and validating the smart contract transaction from the second node:
identifying, at the first node, the organization in the blockchain system associated with the second node;
determining, at the first node, whether the organization is capable of executing the smart contract transaction indicated by the proposal;
for the determining indicating that the organization does not have capability of executing the smart contract transaction indicated by the proposal, returning an error to the second node; and
for the determining indicating that the organization does have capability of executing the smart contract transaction indicated by the proposal, executing an order of transactions provided by an ordering service.

4. The method of claim 3, further comprising:
executing an ordering service for transactions issued to the blockchain system, the ordering service determining an order for executing the request for committing the smart contract transaction from second nodes with other requests for committing smart contract transactions; and
providing the order to the first node.

5. The method of claim 1, further comprising executing an auditing process at a third node of the plurality of nodes, the auditing process comprising:
receiving, at the third node, the smart contract transaction and private data associated with the smart contract transaction; and
executing integrity checks on the smart contract transaction and the private data.

6. The method of claim 1, the method further comprising, for initiation of a test environment:
replacing an identity of the organization in the blockchain system that initiated the proposal in the smart contract transaction and endorsements with the identity and endorsements issued by a test environment manager managing the test environment; and
for the smart contract transaction indicative of a change in a configuration of the system, transforming trust roots for organizations in the blockchain system indicated by organization information in the smart contract transaction.

7. The method of claim 6, the method further comprising launching a new blockchain network on the test environment, the launching facilitated by a test network launcher, the launching comprising:
copying a ledger transformed by the test environment manager and a state database transformed by the test environment manager to each blockchain node in the new blockchain network; and
copying private data transformed by the test environment manager corresponding to organizations in the blockchain system associated with the smart contract transaction to the each blockchain node in the new blockchain network corresponding to the organizations.

8. A blockchain system configured to facilitate a smart contract transaction, the blockchain system comprising:
a plurality of nodes;
wherein a first node of the plurality of nodes comprises a processor, configured to, responsive to receiving a proposal for the smart contract transaction from a second node of the plurality of nodes:
identify an organization in the blockchain system associated with the second node;
determine whether the organization is capable of executing the smart contract transaction indicated by the proposal;
for the determination indicating that the organization does not have capability of executing the smart contract transaction indicated by the proposal, return an error to the second node; and
for the determination indicating that the organization does have capability of executing the smart contract transaction indicated by the proposal, executing the smart contract transaction.

9. The blockchain system of claim 8, wherein the processor is configured to determine whether the organization is capable of executing the smart contract transaction indicated by the proposal by:
determining that the organization is indicative of not having the capability of executing the smart contract transaction indicated by the proposal for the organization being a read-only organization; and
determining that the organization is indicative of having the capability of executing the smart contract transaction indicated by the proposal for the organization not being a read-only organization.

10. The blockchain system of claim 8, wherein the processor is configured to, responsive to receiving a request for committing and validating the smart contract transaction from the second node:
identify the organization in the blockchain system associated with the second node;
determine whether the organization is capable of executing the smart contract transaction indicated by the proposal;
for the determination indicating that the organization does not have capability of executing the smart contract transaction indicated by the proposal, return an error to the second node; and
for the determination indicating that the organization does have capability of executing the smart contract transaction indicated by the proposal, execute an order of transactions provided by an ordering service.

11. The blockchain system of claim 10, further comprising an ordering service comprising another processor configured to determine an order for executing the request for committing the smart contract transaction from second nodes with other requests for committing smart contract transactions; and provide the order to the first node.

12. The blockchain system of claim 8, wherein a third node of the plurality of nodes comprises another processor configured to execute an auditing process, the auditing process comprising:
receiving the smart contract transaction and private data associated with the smart contract transaction; and
executing integrity checks on the smart contract transaction and the private data.

13. The blockchain system of claim 8, wherein an apparatus belonging to the read-only organization comprises another processor, configured to, for receipt of an initiation of a test environment:
replace an identity of the organization in the blockchain system that initiated the proposal in the smart contract transaction and endorsements with the identity and endorsements issued by a test environment manager managing the test environment; and
for the smart contract transaction indicative of a change in a configuration of the system, transform trust roots for organizations in the blockchain system indicated by organization information in the smart contract transaction.

14. The blockchain system of claim 13, wherein the another processor is configured to launch a new blockchain network on the test environment, the launch facilitated by a test network launcher, the launch comprising:
copying a ledger transformed by the test environment manager and a state database transformed by the test environment manager to each blockchain node in the new blockchain network; and
copying private data transformed by the test environment manager corresponding to organizations in the blockchain system associated with the smart contract transaction to the each blockchain node in the new blockchain network corresponding to the organizations.

15. A non-transitory computer readable medium, storing instructions for a blockchain system configured to facilitate a smart contract transaction, the blockchain system comprising a plurality of nodes, the instructions comprising:
responsive to receiving, at a first node from the plurality of nodes, a proposal for the smart contract transaction from a second node of the plurality of nodes:
identifying, at the first node, an organization in the blockchain system associated with the second node;
determining, at the first node, whether the organization is capable of executing the smart contract transaction indicated by the proposal;
for the determining indicating that the organization does not have capability of executing the smart contract transaction indicated by the proposal, returning an error to the second node; and
for the determining indicating that the organization does have capability of executing the smart contract transaction indicated by the proposal, executing the smart contract transaction.
